(19) United States
(12) Patent Application Publication
(10) Pub. No.: US 2022/0268007 A1
(43) Pub. Date: Aug. 25, 2022

(54) Toilet bolt caps

(71) Applicants: David Szymczak, Kokomo, IN (US); Brian Mula, Kokomo, IN (US)

(72) Inventors: David Szymczak, Kokomo, IN (US); Brian Mula, Kokomo, IN (US)

(21) Appl. No.: 17/182,241

(22) Filed: Feb. 23, 2021

(51) Int. Cl. E03D 11/16; F16B 41/00

(52) U.S. Cl. CPC E03D 11/16; F16B 41/002

(57) ABSTRACT

The present invention relates to a toilet bolt cap that has a unique structure which is over twice the size of generally available nuts. This nut ensures better holding power to the toilet seats thus maintain the effectiveness of toilet bolt caps over longer period of time.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to toilets. More particularly, this invention relates to toilet bolt caps.

### Description of the Related Art

A toilet is a standard fixture of indoor plumbing. A toilet is connected to a source of water and is mounted over a floor drain. A toilet is secured in position on the floor with two toilet bolts (sometimes known as T-bolts because of the shape of their heads) that extend upwardly from a closet flange at the mouth of the drain. The toilet contains oblong holes in its base that are placed over the bolts. The term “oblong” is used herein to refer to an elongated shape in which one dimension is greater than a perpendicular dimension. Washers and nuts are then inserted onto the bolts and tightened.

Exposed nuts and bolts are unsightly so they are typically hidden with a porcelain or plastic cover. The common practice is to use a cover consisting of a flat base that is placed onto the bolt under the washer and nut, and a cap that fits over the bolt and snaps onto the base. Toilet bolts are generally about 60 mm (about two and one-half inches) long to accommodate varying thicknesses of toilet bases and varying thicknesses of flooring. In many installations, the bolt is much longer than needed. In other words, the bolt extends above the toilet base by more than about 10 to 15 mm. Conventional bolt caps are not deep enough to fit over such a long bolt. As a result, it is frequently necessary to cut off the end of the bolt so that the cap will cover it and snap onto the disk. Cutting off the end of the bolt is a time-consuming and difficult procedure. Furthermore, if a different toilet with a thicker base is installed later, or if a thicker floor covering is added later, the cut-off bolt may not he long enough to attach a nut.

A variety of toilet bolt covers have been disclosed. Bosler, U.S. Pat. No. 3,241,427, Mar. 22, 1966, Isaacs, U.S. Pat. No. 3,601,823, Aug. 31, 1971, and Fraleigh, U.S. Pat. No. 6,698,986, Mar. 2, 2004, disclose toilet bolt caps that have internal receptacles for mating with the toilet bolt. These bolt caps do not contain a base and therefore do not form an effective seal around the bolt, nut, and washer. Tooman et al., U.S. Pat. No. 6,808,350, issued Oct. 26, 2004, disclose deep bolt caps that are installed on anchor bolts by pounding onto the nut and are held in place frictionally. The Tooman et al. caps also lack a base.

Cabiran, U.S. Pat. No. 6,053,683, Apr. 25, 2000, and Fraleigh, U.S. Pat. No. 6,125,479, Oct. 3, 2000, disclose bolt: covers having caps with internal threads that mate with a base having external threads. The bases are relatively thick and the nut: sits above all the threads. Accordingly, the base can be used only with bolts that extend relatively far above the toilet base. Furthermore, there is no means for preventing the base from rotating. Accordingly, removing the cap may be very difficult because the base tends to rotate with the cap.

There are multiple solutions that have been presented in prior art. However, these solutions are limited and restricted to their conventional architecture, installation system and have considerable shortcomings which adversely affect the convenience with which they can be used. Morever, the ease-of-use ability of these assemblies is also questionable.

Accordingly, there is a demand for an improved toilet bolt cover. More particularly, there is a demand for a toilet bolt cover that completely and securely seals the end of the toilet bolt, the nut, and the washer, that accommodates toilet bolts of varying lengths, and that is easily installed and easily removed.

Current toilet bolt covers are utilitarian in design and fail to seize the opportunity to offer individuals an additional way for them to decorate their home. Therefore, it would be advantageous to design a toilet bolt cover solves by providing anyone who needs to cover their toilet bolts with a sustainable and unique solution. The nut proposed is 0.70 inches which is over twice the size of the normal nut. Existing products only attach to average sized nuts. However, the current proposed design shows the toilet bolt cap design which adds additional holding power to the toilet bolt caps and allow them not to pop off when moved from cleaning, pets, or children. The present invention is easy to install over an exposed toilet bolt and comes in a variety of sizes, shapes, and designs so that anyone can find a toilet bolt cover that fits their style.

None of the previous inventions and patents, taken either singly or in combination, are seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of toilet bolt cover with twice the size of normal nut.

The general object of this invention is to provide an improved toilet bolt cover. More particular objects are to provide a toilet bolt cover that completely and securely seals the end of the toilet bolt, the nut, and the washer, that accommodates toilet bolts of varying lengths, and that is easily installed and easily removed.

It is another object of the present invention to provide a toilet bolt nut with enlarged nut size to add additional holding power to the toilet bolt cap.

Another object of the present invention is to provide a toilet bolt cover that is available in a wide variety of shapes, colors, and designs.

Yet another object of the present invention is to provide a toilet bolt cover that protects individuals from injury from an exposed toilet bolt.

It is also the objective of the invention to provide a smart assembly which provides ease of use and convenience to everyone.

It is a further aspect of the present invention to provide a new and improved assembly which is developed from reliable materials and sustains its effectiveness over a longer period of time.

Thus, it is the objective to provide a new and improved assembly of a toilet bolt cover that is easy to secure over the exposed portion of a toilet bolt. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 discloses the complete assembled view of toilet bolt cap as per preferred embodiments of the invention.

FIG. 2 discloses the various configurations as per preferred embodiments of the invention.

FIG. 3 discloses the top cap view of toilet bolt as per preferred embodiments of the invention.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Toilet bolts are critical to the function of the toilet because they keep the fixture in place during use, but the toilet bolts require covers to protect individuals from the exposed threaded portions and make the structure more aesthetically pleasing. However, the caps used to cover the toilet bolts often fall over time due to multiple reasons.

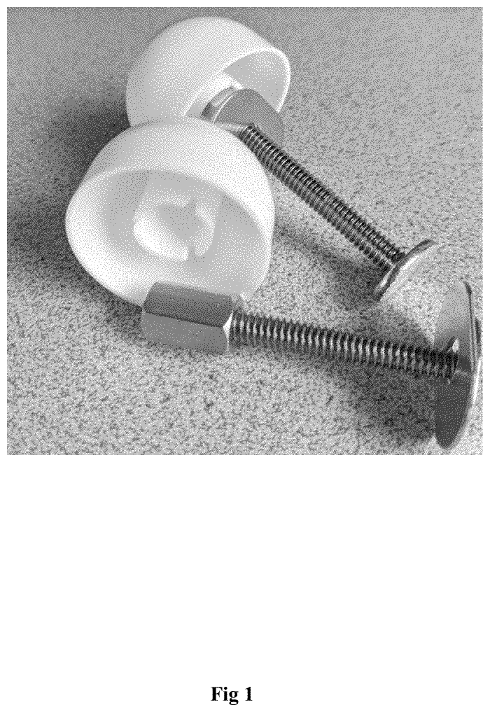

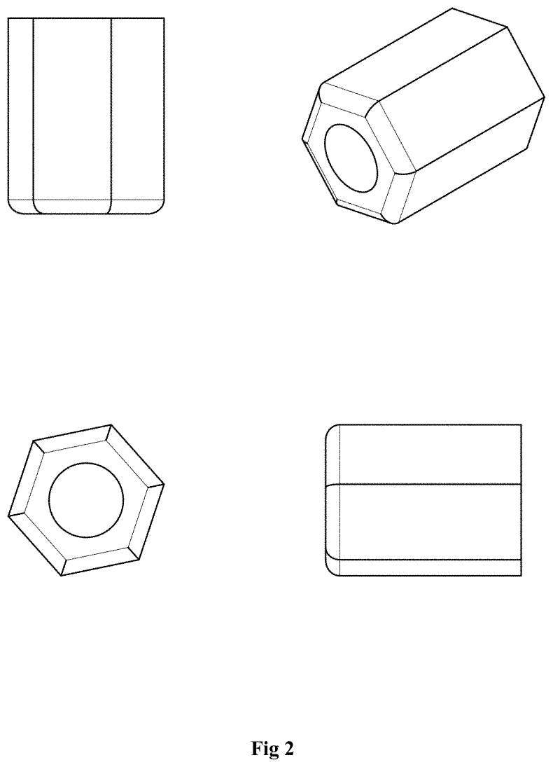

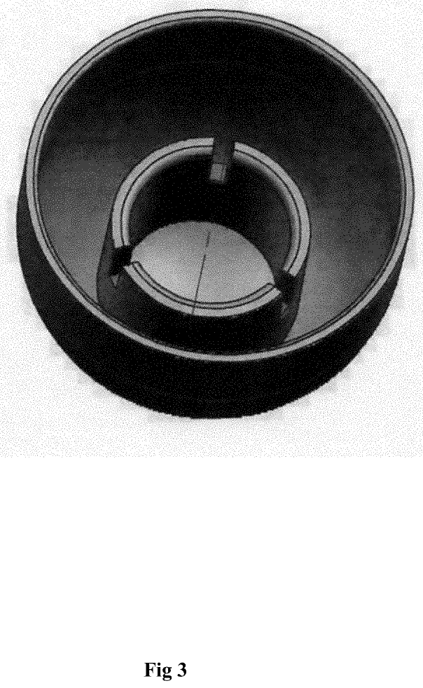

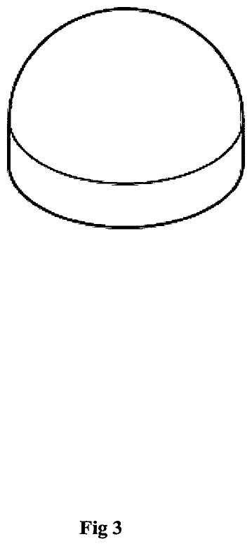

Referring now to FIG. 1, there is shown a perspective view of the present invention aligned with the exposed portion of a bolt, prior to be secured thereon. The present invention comprises a cover body and an elongated recess. The cover body as depicted is dome-shaped however the cover body can be provided in a wide variety of aesthetically-pleasing designs. No claim is made as to the specific shape, design, color, or configuration of the present decorative toilet bolt cover. The cover body may be composed of ceramic, plastic, or any other type of suitable material. The nut used in proposed assembly is of 0.70 inches which is twice the size of generally available nut assemblies. This allows additional holding power to the toilet bowl cap and allow them not to pop off with wear and tear.

The present invention is designed to be available in a wide range of designs and sizes in order to provide users with a large variety of potential options for their bathrooms. The present invention also functions as a traditional bolt cover by protecting users from the potential hazard of an exposed toilet bolt. The exposed threaded portion of a toilet bolt can be dangerous to users because it is a hard protuberance with jagged, threaded edges that could potentially hurt users in a variety of ways. Therefore, there is a need to cover the exposed threaded portion with a more rounded, less dangerous covering that will help prevent injuries. This bolt covering need not be strictly utilitarian and ugly, as is the case with current bolt covers, despite its utilitarian purpose. Individuals are always looking for new and creative ways of decorating their bathroom and the present invention provides users with a previously unrecognized opportunity to do so.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

II: toilet bolt cover, comprising:
a cover body having a flat lower surface, a nut of double the size of traditional nuts, an aperture through said lower surface, and an elongated recess extending into said cover body from said aperture;
said elongated recess adapted to accept an exposed toilet bolt therein;
said cover body and said elongated recess being adapted to shroud the entirety of said toilet bolt length;
said cover body a dome shape.

II. The toilet bolt cover of claim 1, further comprises of nut double the size of available nuts thus ensuring effectiveness and performance over longer period of time.
